(19) United States
(12) Patent Application Publication
(10) Pub. No.: US 2018/0312730 A1
(43) Pub. Date: Nov. 1, 2018

(54) RESIN COMPOSITION FOR SEALING AND ELECTRONIC COMPONENT DEVICE

(71) Applicant: SUMITOMO BAKELITE CO., LTD., Tokyo (JP)

(72) Inventors: Masaru NAKAO, Tokyo (JP); Hirofumi KURODA, Tokyo (JP)

(73) Assignee: SUMITOMO BAKELITE CO., LTD., Tokyo (JP)

(21) Appl. No.: 15/569,575

(22) PCT Filed: Apr. 30, 2015
(86) PCT No.: PCT/JP2015/062937

§ 371 Date: Oct. 26, 2017

(51) Int. Cl. C09J 11/06; C09J 163/00; C09K 3/10; C08K 5/3415; C08K 5/20; C08K 5/50; C08K 5/54; C08K 5/08

(52) U.S. Cl. CPC C09J 11/06; C09J 163/00; C09K 3/1006; C08K 5/08; C08K 5/20; C08K 5/50; C08K 5/5403; C08K 5/3415

(57) ABSTRACT

A resin composition for sealing of the present invention contains an epoxy resin (A), a curing agent (B), an inorganic filler (C), and a compound (D) represented by Formula (1). In Formula (1), R¹ represents a polar group or a hydrocarbon group. An electronic component device (10) of the present invention has an electronic component (11) and a sealing material (12) sealing the electronic component (11), in which the sealing material (12) is a cured substance of the resin composition for sealing.

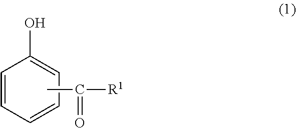

### TECHNICAL FIELD

The present invention relates to a resin composition for sealing and an electronic component device using the resin composition.

### BACKGROUND ART

Electronic components such as a diode, a transistor, and an integrated circuit are distributed to the market or incorporated into electronic instruments, as electronic component devices sealed with a cured substance of an epoxy resin composition or the like. Generally, the epoxy resin composition used in the sealing material is composed of an epoxy resin, a phenolic resin-based curing agent, an inorganic filler, a coupling agent, and the like. In recent years, as electronic instruments have become increasingly compactified, lightened, and improved in terms of performance, electronic components have been integrated on a large scale, and accordingly, the performance required for the sealing material (resin composition for sealing) has also improved. Specific examples of the performance required for the sealing material include adhesion, solder resistance, fluidity, heat resistance, high-temperature storage characteristics, and the like.

Under these circumstances, a resin composition for sealing a semiconductor that contains a mercapto group-containing compound such as mercapto group-containing alkoxysilane is developed (see Patent Document 1). The addition of a mercapto group-containing compound brings about an effect of improving the adhesion with respect to electronic components and the like.

Meanwhile, in recent years, as a material such as a bonding wire used for connecting an electronic component to a lead frame, instead of gold, inexpensive copper has been used. However, electronic component devices including a copper wire do not have sufficient high-temperature storage characteristics in some cases. For the electronic component devices in which a copper member such as a copper wire is used, much better high-temperature storage characteristics are required, and hence there is a demand for the development of a resin composition for sealing that is suitable for sealing such electronic components.

### RELATED DOCUMENT

### Patent Document

[Patent Document 1] Japanese Laid-open Patent Publication No. 2008-201873

### SUMMARY OF THE INVENTION

### Technical Problem

The present invention has been made in consideration of the circumstances described above, and an object thereof is to provide a resin composition for sealing which has sufficient adhesion and enables an electronic component device obtained using the resin composition to exhibit excellent high-temperature storage characteristics, and to provide an electronic component device obtained using the resin composition for sealing as a sealing material.

### Solution to Problem

A resin composition for sealing according to a first invention for achieving the aforementioned object contains an epoxy resin (A), a curing agent (B), an inorganic filler (C), and a compound (D) represented by Formula (1).

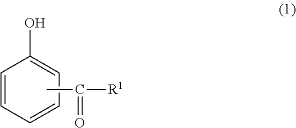

(In Formula (1), R¹ represents a polar group or a hydrocarbon group.)

In the resin composition for sealing according to the first invention, R¹ preferably represents a hydroxyl group, an alkoxy group, or a primary, secondary, or tertiary amino group.

In the resin composition for sealing according to the first invention, R¹ more preferably represents a secondary or tertiary amino group.

In the resin composition for sealing according to the first invention, R¹ is even more preferably represented by Formula (2).

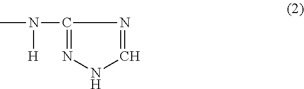

In the resin composition for sealing according to the first invention, a content of the compound (D) is preferably equal to or greater than 0.01% by mass and equal to or less than 1% by mass. The content of each component is a ratio with respect to the total amount of the resin composition for sealing (hereinafter, the same shall be applied).

The resin composition for sealing according to the first invention preferably further contains a coupling agent (E), and the coupling agent (E) preferably includes a silane coupling agent (E1) having a mercapto group.

In the resin composition for sealing according to the first invention, a content of the silane coupling agent (E1) having a mercapto group is preferably equal to or greater than 0.01% by mass and equal to or less than 0.1% by mass.

The resin composition for sealing according to the first invention preferably further contains a curing accelerator (F), and the curing accelerator (F) is preferably at least one kind of phosphorus atom-containing compound selected from the group consisting of a tetrasubstituted phosphonium compound and an adduct of a phosphine compound and a quinone compound.

The resin composition for sealing according to the first invention is preferably used for sealing an electronic component to which a copper wire is connected.

An electronic component device according to a second invention for achieving the aforementioned object includes an electronic component and a sealing material sealing the electronic component, in which the sealing material is a cured substance of the resin composition for sealing according to the first invention.

The electronic component device according to the second invention preferably has a copper wire connected to the electronic component.

### Advantageous Effects of Invention

The resin composition for sealing according to the first invention contains a specific compound (D) having a hydroxybenzoyl group. Therefore, the resin composition can achieve both the sufficient adhesion and the excellent high-temperature storage characteristics of the obtained electronic component device.

In the electronic component device according to the second invention, the resin composition for sealing according to the first invention is used as a sealing material. Therefore, the adhesion between the sealing material and the electronic component or the like is sufficient, and the high-temperature storage characteristics are also excellent.

### BRIEF DESCRIPTION OF THE DRAWINGS

The aforementioned object and other objects, characteristics, and advantages will be further clarified by suitable embodiments described below and the following drawings attached thereto.

FIG. 1 is a cross-sectional view showing an electronic component device according to a second embodiment of the present invention.

### DESCRIPTION OF EMBODIMENTS

Hereinafter, the embodiments specifically showing the present invention will be described with reference to the attached drawings as appropriate.

[Resin Composition for Sealing]

The resin composition for sealing according to a first embodiment of the present invention contains an epoxy resin (A), a curing agent (B), an inorganic filler (C), and a compound (D).

[Epoxy Resin (A)]

The epoxy resin (A) refers to a compound (a monomer, an oligomer, and a polymer) having two or more epoxy groups in one molecule, and the molecular weight as well as the molecular structure thereof are not particularly limited. Examples of the epoxy resin (A) include a crystalline epoxy resin such as a biphenyl-type epoxy resin, a bisphenol-type epoxy resin, or a stilbene-type epoxy resin; a novolac-type epoxy resin such as a phenol novolac-type epoxy resin or a cresol novolac-type epoxy resin; a polyfunctional epoxy resin such as a triphenol methane-type epoxy resin or an alkyl-modified triphenol methane-type epoxy resin; a phenol aralkyl-type epoxy resin such as a phenol aralkyl-type epoxy resin having a phenylene skeleton or a phenol aralkyl-type epoxy resin having a biphenylene skeleton; a naphthol-type epoxy resin such as dihydroxynaphthalene-type epoxy resin or an epoxy resin obtained by the glycidyl etherification of a dimer of dihydroxynaphthalene; a triazine nucleus-containing epoxy resin such as triglycidyl isocyanurate or monoallyl diglycidyl isocyanurate; a bridged cyclic hydrocarbon compound-modified phenol-type epoxy resin such as dicyclopentadiene-modified phenol-type epoxy resin; and the like. One kind of these may be used singly, or two or more kinds thereof may be used in combination.

As the epoxy resin (A), a phenol aralkyl-type epoxy resin represented by Formula (3) and a biphenyl-type epoxy resin represented by Formula (4) are preferable.

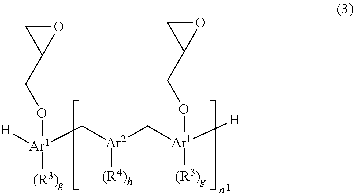

In Formula (3), Ar¹ represents a phenylene group (a group including a phenol structure obtained by removing hydrogen atoms from phenol by the number of bonds) or a naphthylene group (a group including a naphthalene structure obtained by removing hydrogen atoms from naphthalene by the number of bonds). In a case where Ar¹ represents a naphthylene group, a glycidyl ether group may be bonded to any of the α-position and the β-position. Ar² represents any one of a phenylene group, a biphenylene group (a group including a biphenylene structure obtained by removing hydrogen atoms from biphenyl by the number of bonds), and a naphthylene group. R³ and R⁴ each independently represent a hydrocarbon group having 1 to 10 carbon atoms. g represents an integer of 0 to 5 (here, in a case where Ar¹ represents a phenylene group, g represents an integer of 0 to 3). h represents an integer of 0 to 8 (here, in a case where Ar² represents a phenylene group, h represents an integer of 0 to 4, and in a case where Ar² represents a biphenylene group, h represents an integer of 0 to 6). n¹ represents a degree of polymerization, and the average thereof is 1 to 3.

As Ar¹, a phenylene group is preferable. As Ar², a phenylene group or a biphenylene group is preferable. In a case where Ar² represents a phenylene group or a biphenylene group (in a case where a phenylene skeleton or a biphenylene skeleton is introduced into the resin), flame retardancy can also be improved. In a case where g and h in R³ and R⁴ are not zero, examples of the hydrocarbon group having 1 to 10 carbon atoms include an alkyl group such as a methyl group or an ethyl group, an alkenyl group such as a vinyl group, an aryl group such as a phenyl group, and the like. g and h are preferably zero.

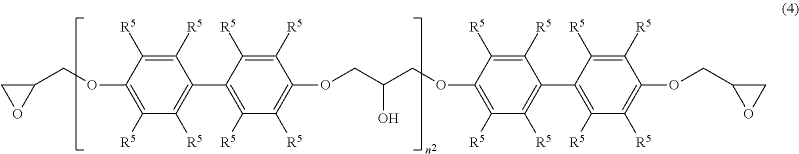

In Formula (4), a plurality of R⁵'s each independently represent a hydrogen atom or a hydrocarbon group having 1 to 4 carbon atoms. n² represents a degree of polymerization, and the average thereof is 0 to 4. Examples of the hydrocarbon group having 1 to 4 carbon atoms include an alkyl group such as a methyl group or an ethyl group, an alkenyl group such as a vinyl group, and the like.

Although the content of the epoxy resin (A) is not particularly limited, the lower limit thereof is preferably 2% by mass and more preferably 4% by mass. In a case where the content of the epoxy resin (A) is equal to or greater than the aforementioned lower limit, sufficient adhesion and the like can be exhibited. The upper limit of the content of the epoxy resin (A) is preferably 20% by mass, and more preferably 10% by mass. In a case where the content of the epoxy resin (A) is equal to or less than the aforementioned upper limit, sufficient low water absorption properties, low thermal expansion properties, or the like are exhibited.

[Curing Agent (B)]

The curing agent (B) is not particularly limited as long as it is a component that can cure the epoxy resin (A). Examples thereof include polyaddition-type curing agent, a catalytic curing agent, and a condensation-type curing agent.

Examples of the polyaddition-type curing agent include polyamine compounds including an aliphatic polyamine such as diethylenetriamine (DETA), triethylenetetramine (TETA), or meta-xylenediamine (MXDA), an aromatic polyamine such as diaminodiphenylmethane (DDM), m-phenylenediamine (MPDA), or diaminodiphenylsulfone (DDS), dicyandiamide (DICY), organic acid dihydrazide, and the like; acid anhydrides including an alicyclic acid anhydride such as hexahydrophthalic anhydride (HHPA) or methyltetrahydrophthalic anhydride (MTHPA) and an aromatic acid anhydride such as trimellitic anhydride (TMA), pyromellitic anhydride (PMDA), benzophenonetetracarboxylic dianhydride (BTDA); a polyphenol compound such as a novolac-type phenol resin or a phenol polymer; a polymercaptan compound such as polysulfide, thioester, or thioether; an isocyanate compound such as an isocyanate prepolymer or blocked isocyanate; organic acids such as carboxylic acid-containing polyester resin; phenolic resin-based curing agents which will be specifically described below; and the like.

Examples of the catalytic curing agent include a tertiary amine compound such as benzyldimethylamine (BDMA) or 2,4,6-tris dimethylaminomethylphenol (DMP-30); an imidazole compound such as 2-methylimidazole or 2-ethyl-4-methylimidazole (EMI 24); a Lewis acid such as a BF₃ complex; and the like.

Examples of the condensation-type curing agent include a resol-type phenolic resin; a urea resin such as a methylol group-containing urea resin; a methylol group-containing melamine resin; and the like.

Among these, as the curing agent (B), a phenolic resin-based curing agent is preferable. By the use of the phenolic resin-based curing agent, flame resistance, moisture resistance, electrical characteristics, curing properties, storage stability, and the like can be exhibited to be well-balanced. The phenolic resin-based curing agent refers to a compound (a monomer, an oligomer, and a polymer) having two or more phenolic hydroxyl groups in a molecule, and the molecular weight as well as the molecular structure thereof are not particularly limited.

Examples of the phenolic resin-based curing agent include a novolac-type resin such as a phenol novolac resin or a cresol novolac resin; a polyfunctional phenolic resin such as a triphenol methane-type phenolic resin; a modified phenolic resin such as a terpene-modified phenolic resin or a dicyclopentadiene-modified phenolic resin; an aralkyl-type resin such as a phenol aralkyl resin having a phenylene skeleton and/or a biphenylene skeleton or a naphthol aralkyl resin having a phenylene and/or biphenylene skeleton; a bisphenol compound such as bisphenol A or bisphenol F; and the like. One kind of these may be used singly, or two or more kinds thereof may be used in combination.

As the curing agent (B), an aralkyl-type resin represented by Formula (5) is preferable.

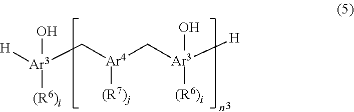

In Formula (5), Ar³ represents a phenylene group (a group including a phenol structure obtained by removing hydrogen atoms from phenol by the number of bonds) or a naphthylene group (a group including a naphthalene structure obtained by removing hydrogen atoms from naphthalene by the number of bonds). In a case where Ar³ represents a naphthylene group, a hydroxyl group may be bonded to any one of the α-position and the β-position. Ar⁴ represents any one of a phenylene group, a biphenylene group (a group including a biphenylene structure obtained by removing hydrogen atoms from biphenyl by the number of bonds), and a naphthylene group. R⁶ and R⁷ each independently represent a hydrocarbon group having 1 to 10 carbon atoms. i represents an integer of 0 to 5 (here, in a case where Ar³ represents a phenylene group, i represents an integer of 0 to 3). j represents an integer of 0 to 8 (here, in a case where Ar⁴ represents a phenylene group, j represents an integer of 0 to 4, and in a case where Ar⁴ represents a biphenylene group, j represents an integer of 0 to 6). n³ represents a degree of polymerization, and the average thereof is 1 to 3.

As Ar³, a phenylene group is preferable. As Ar⁴, a phenylene group or a biphenylene group is preferable. In a case where Ar⁴ represents a phenylene group or a biphenylene group (in a case where a phenylene skeleton or a bipenylene skeleton is introduced into the resin), flame retardancy and the like can also be improved. In a case where i and j in R⁶ and R⁷ are not zero, examples of the hydrocarbon group having 1 to 10 carbon atoms include those represented by R³ and R⁴ in Formula (3). i and j are preferably zero.

Although the content of the curing agent (B) is not particularly limited, the lower limit thereof is preferably 0.5% by mass and more preferably 2% by mass. In a case where the content of the curing agent (B) is equal to or greater than the aforementioned lower limit, sufficient curing properties, adhesion, and the like can be exhibited. The upper limit of the content of the curing agent (B) is preferably 15% by mass, and more preferably 10% by mass. In a case where the content of the curing agent (B) is equal to or less than the aforementioned upper limit, sufficient fluidity and the like can be exhibited.

[Inorganic Filler (C)]

As the inorganic filler (C), it is possible to use inorganic fillers used in general resin compositions for sealing. Examples of the inorganic filler (C) include silica such as molten spherical silica, molten pulverized silica, or crystal silica, talc, alumina, titanium white, silicon nitride, and the like. Among these, silica is preferable, and molten spherical silica is more preferable. One kind of the inorganic filler (C) may be used singly, or two or more kinds thereof may be used in combination. The inorganic filler (C) has a spherical shape, and preferably has a wide particle size distribution. The use of such an inorganic filler makes it possible to inhibit an increase in melt viscosity of the resin composition for sealing and to increase the content of the inorganic filler (C). As a method for adding the inorganic filler (C) having a wide particle size distribution to the resin composition for sealing, there is a method of using plural kinds of inorganic fillers having different average particle sizes by mixing them together. Furthermore, the surface of the inorganic filler (C) may be treated with a coupling agent. If necessary, the inorganic filler (C) may be used after being pre-treated with an epoxy resin or the like.

Although the average particle size of the inorganic filler (C) is not particularly limited, the lower limit thereof is preferably 0.1 μm and more preferably 0.3 μm. The upper limit thereof is preferably 40 μm, and more preferably 35 μm. The lower limit of a specific surface area of the inorganic filler (C) is preferably 1 m²/g, and more preferably 3 m²/g. The upper limit thereof is preferably 10 m²/g, and more preferably 7 m²/g. In a case where the average particle size or the specific surface area of the inorganic filler is equal to or greater than the aforementioned lower limit and equal to or less than the aforementioned upper limit, fluidity, low water absorption properties, and the like can be improved.

If necessary, it is preferable that two or more kinds of inorganic fillers within the above preferred range, for example, an inorganic filler having an average particle size of equal to or greater than 0.1 μm and equal to or less than 1 μm and an inorganic filler having an average particle size of equal to or greater than 10 μm and equal to or less than 40 μm, are used in combination.

Although the content of the inorganic filler (C) is not particularly limited, the lower limit thereof is preferably 70% by mass and more preferably 80% by mass. In a case where the content of the inorganic filler (C) is equal to or greater than the aforementioned lower limit, sufficient low water absorption properties, low thermal expansion properties, and the like can be exhibited. The upper limit of the content of the inorganic filler (C) is preferably 95% by mass, and more preferably 92% by mass. In a case where the content of the inorganic filler (C) is equal to or less than the aforementioned upper limit, sufficient fluidity and the like can be exhibited.

[Compound (D)]

The compound (D) is a compound represented by Formula (1). One kind of the compound (D) may be used singly, or two or more kinds thereof may be used in combination. The resin composition for sealing of the present embodiment contains a specific compound (D) having a hydroxybenzoyl group. Therefore, the composition can achieve both the sufficient adhesion and the excellent high-temperature storage characteristics of the obtained electronic component device for the following reason. Although there is no certainty, for example, it is considered that because an electron-donating hydroxyl group is linked to an electron-withdrawing carbonyl group on a benzene ring, an appropriate polarization state may be expressed, and hence the affinity of the compound (D) in such a state with a metal included in an electronic component may be improved. It is considered that in a case where R¹ represents a polar group, the affinity may be further improved. It is considered that consequently, the adhesion of the cured substance (sealing material) of the resin composition for sealing with respect to a substance to be sealed such as an electronic component may be improved, the compound (D) may capture the metal atoms diffused into the cured substance from a bonding wire or the like, and hence the deterioration of high-temperature storage characteristics may be inhibited. In order to bring about the aforementioned effect by creating a better polarization state, it is more preferable that the hydroxyl group and the carbonyl group are disposed in an ortho-position or a para-position.

The compound (D) preferably has a structure which does not have a sulfur atom, particularly, a mercapto group. A compound having a sulfur atom, particularly, a mercapto group results in the deterioration of high-temperature storage characteristics in some cases. Therefore, by using the compound (D) which does not have a sulfur atom, particularly, a mercapto group, the deterioration of high-temperature storage characteristics can be inhibited.

R¹ in Formula (1) represents a polar group or a hydrocarbon group. The polar group refers to a group (atomic group) in which polarization occurs due to atoms with high electronegativity such as an oxygen atom, a nitrogen atom, or a halogen atom. Specifically, examples of the polar group include a hydroxyl group (—OH), an alkoxy group, a primary amino group (—NH₂), a secondary amino group (—NHR, R represents any substituent), a tertiary amino group (—NR₂, two R's represent any substituents, may be the same as or different from each other, and may form a ring structure by being bonded to each other), a heterocyclic group, a hydrocarbon group having a hydroxyl group, a carboxyl group, an amino group, a halogen atom, or the like as a substituent, and the like.

Examples of the alkoxy group represented by R¹ include a methoxy group, an ethoxy group, a propoxy group, a phenoxy group, benzyloxy group, and the like. Examples of a substituent (R) that the secondary or tertiary amino group has include a hydrocarbon group, a heterocyclic group, a hydrocarbon group having the aforementioned substituent, and the like. Examples of the hydrocarbon group represented by R¹ or R include a hydrocarbon group having 1 to 20 carbon atoms. Specifically, examples thereof include an alkyl group such as a methyl group or an ethyl group, an alkenyl group such as a vinyl group or an allyl group, an aryl group such as a phenyl group, a naphthyl group, or a tolyl group, and the like. Examples of the heterocyclic group represented by R¹ or R include an aromatic heterocyclic group such as a furyl group, a pyridyl group, a thienyl group, or a triazole group, an oxanyl group, a piperidinyl group, and the like. Examples of the halogen atom include a chlorine atom, a fluorine atom, and the like.

R¹ preferably represents a polar group such as a hydroxyl group, an alkoxy group, or a primary, secondary, or tertiary amino group. It is considered that in a case where R¹ represents such an electron-donating group, a better polarization state may be expressed. Among the alkoxy groups, an alkoxy group having 1 to 3 carbon atoms is preferable, and a methoxy group is more preferable. R¹ more preferably represents a hydroxyl group or a primary, secondary, or tertiary amino group, even more preferably represents a primary, secondary, or tertiary amino group, still more preferably represents a secondary or tertiary amino group, and particularly preferably represents a secondary amino group. The secondary or tertiary amino group preferably has a polar group as a substituent. As the polar group that the secondary or tertiary amino group has, a heterocyclic group is preferable. The heterocyclic group is more preferably a nitrogen atom-containing heterocyclic group or a nitrogen atom-containing aromatic heterocyclic group, even more preferably a nitrogen atom-containing aromatic heterocyclic group, and particularly preferably a triazole group. The triazole group refers to a monovalent group obtained by removing one hydrogen atom from triazole. The triazole may be 1,2,3-triazole or 1,2,4-triazole, but is preferably 1,2,4-triazole. As R¹, a group (a secondary amino group represented by General Formula —NHR in which R represents 2H-1,2,4-triazol-5-yl group) represented by Formula (2) is particularly preferable.

In a case where R¹ in compound (D) represents a hydroxyl group or a group (a secondary amino group represented by General Formula —NHR in which R represents 2H-1,2,4-triazol-5-yl group) represented by Formula (2), the high-temperature storage characteristics and adhesion are particularly excellent.

For example, in a case where a compound, in which R¹ is represented by Formula (2), is used as the compound (D), two kinds of compounds generating such a compound through a reaction may be used by being mixed together. Examples of the two kinds of compounds include a combination of hydroxybenzoic acid and aminotriazole, and the like.

Although the content of the compound (D) is not particularly limited, the lower limit thereof is preferably 0.01% by mass, more preferably 0.02% by mass, and even more preferably 0.03% by mass. The upper limit of the content of the compound (D) is preferably 1% by mass, more preferably 0.5% by mass, and even more preferably 0.3% by mass. In a case where the content of the compound (D) is equal to or greater than the aforementioned lower limit and equal to or less than the aforementioned upper limit, sufficient adhesion and the high-temperature storage characteristics can be exhibited without greatly affecting other characteristics.

[Coupling Agent (E)]

The resin composition for sealing may further contain the coupling agent (E). The coupling agent (E) is a component that links the epoxy resin (A), which is a resin component, or the like to the inorganic filler (C). Examples of the coupling agent (E) include silane coupling agents such as epoxysilane, aminosilane, mercaptosilane (a silane coupling agent containing a mercapto group) (E1), and the like. One kind of the coupling agent (E) may be used singly, or two or more kinds thereof may be used in combination.

Examples of the epoxysilane include γ-glycidoxypropyl triethoxysilane, γ-glycidoxypropyl trimethoxysilane, β-(3,4 epoxycyclohexyl)ethyl trimethoxysilane, and the like.

Examples of the aminosilane include γ-aminopropyl triethoxysilane, γ-aminopropyl trimethoxysilane, N-phenyl-γ-aminopropyl trimethoxysilane (referred to as anilinosilane in some cases), and the like.

Examples of the mercaptosilane (E1) include γ-mercaptopropyl trimethoxysilane, 3-mercaptopropylmethyl dimethoxysilane, and the like. The mercaptosilane also includes compounds performing the same function through thermal decomposition, such as bis(3-triethoxysilylpropyl)tetrasulfide and bis(3-triethoxysilylpropyl)disulfide.

Among the coupling agents (E), it is preferable to use epoxysilane, anilinosilane, mercaptosilane (E1), or a combination of these. The anilinosilane is effective for improving fluidity, and the mercaptosilane (E1) can improve adhesion. As described above, the high-temperature storage characteristics of the compound having a mercapto group are not sufficient in some cases. However, in a case where the mercaptosilane (E1) and the compound (D) of the present invention are used in combination, excellent high-temperature storage characteristics and excellent adhesion can be simultaneously achieved.

Although the content of the coupling agent (E) is not particularly limited, the lower limit thereof is preferably 0.01% by mass and more preferably 0.05% by mass. The upper limit thereof is preferably 1% by mass, and more preferably 0.5% by mass. In a case where the content of the coupling agent (E) is equal to or greater than the aforementioned lower limit and equal to or less than the aforementioned upper limit, the function of the coupling agent (E) can be effectively exhibited.

In a case where the compound (D) and the mercaptosilane (E1) are used in combination, the lower limit of the content of the mercaptosilane is preferably 0.01% by mass and more preferably 0.02% by mass. In a case where the content of the mercaptosilane (E1) is equal to or greater than the aforementioned lower limit, the adhesion can be effectively improved. The upper limit of the content of the mercaptosilane (E1) is preferably 0.1% by mass, and more preferably 0.07% by mass. In a case where the content of the mercaptosilane (E1) is equal to or less than the aforementioned upper limit, the high-temperature storage characteristics can be further improved.

[Curing Accelerator (F)]

The resin composition for sealing may further contain the curing accelerator (F). The curing accelerator (F) is a component that functions to accelerate the reaction between the epoxy resin (A) and the curing agent (B). As the curing accelerator (F), generally used curing accelerators are used.

Examples of the curing accelerator (F) include a phosphorus atom-containing compound such as organic phosphine, a tetrasubstituted phosphonium compound, a phosphobetaine compound, an adduct of a phosphine compound and a quinone compound, or an adduct of a phosphonium compound and a silane compound; a nitrogen atom-containing compound such as an amidine or a tertiary amine including 1,8-diazabicyclo (5,4,0) undecene-7, benzyldimethylamine, or 2-methylimidazole or a quaternary salt of the above amidine or amine; and the like. Among these, one kind of compound may be used singly, or two or more kinds of compounds may be used in combination. Among these, from the viewpoint of curing properties, adhesion, and the like, a phosphorus atom-containing compound is preferable. From the viewpoint of solder resistance, fluidity, and the like, a phosphobetaine compound and an adduct of a phosphine compound and a quinone compound are particularly preferable. Furthermore, a phosphorus atom-containing compound such as a tetrasubstituted phosphonium compound or an adduct of a phosphonium compound and a silane compound is particularly preferable, because such a compound less contaminates a mold during continuous molding.

(Organic Phosphine)

Examples of the organic phosphine include a primary phosphine such as ethyl phosphine or phenyl phosphine; a secondary phosphine such as dimethyl phosphine or diphenyl phosphine; a tertiary phosphine such as trimethyl phosphine, triethyl phosphine, tributyl phosphine, or triphenylphosphine; and the like.

(Tetrasubstituted Phosphonium Compound)

Examples of the tetrasubstituted phosphonium compound include a compound represented by Formula (6).

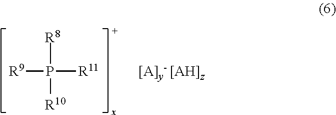

In Formula (6), P represents a phosphorus atom. R⁸, R⁹, R¹⁰, and R¹¹ each represent an aromatic group or an alkyl group. [A]⁻ represents an aromatic organic acid anion having at least one functional group selected from a hydroxyl group, a carboxyl group, and a thiol group on an aromatic ring. AH represents an aromatic organic acid having at least one functional group selected from a hydroxyl group, a carboxyl group, and a thiol group on an aromatic ring. x and y each represent a number of 1 to 3, z represents a number of 0 to 3, and x equals y.

The compound represented by Formula (6) can be obtained in the manner described below, but is not limited thereto. First, tetrasubstituted phosphonium halide, an aromatic organic acid, and a base are added to an organic solvent and homogeneously mixed together such that an aromatic organic acid anion occurs in the solution system. Then, by adding water thereto, the compound represented by Formula (6) can be precipitated.

In the compound represented by Formula (6), R⁸, R⁹, R¹⁰, and R¹¹ bonded to a phosphorus atom preferably each represent a phenyl group; AH preferably represents a compound having a hydroxyl group on an aromatic ring, that is, phenols; and [A]—preferably represents an anion of the phenols. Examples of the phenols include monocyclic phenols such as phenol, cresol, resorcine, and catechol, condensed polycyclic phenols such as naphthol, dihydroxynaphthalene, and anthraquinone, bisphenols such as bisphenol A, bisphenol F, and bisphenol S, polycyclic phenols such as phenylphenol and biphenol, and the like.

(Phosphobetaine Compound)

Examples of the phosphobetaine compound include a compound represented by Formula (7).

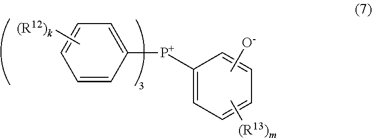

In Formula (7), R¹² represents an alkyl group having 1 to 3 carbon atoms. R¹³ represents a hydroxyl group. k represents an integer of 0 to 5. m represents an integer of 0 to 3.

The compound represented by Formula (7) is obtained in the following manner, for example. The compound is obtained through a step of bringing a triaromatic substituted phosphine, which is a tertiary phosphine, into contact with a diazonium salt such that the triaromatic substituted phosphine and the diazonium group of the diazonium salt are substituted. However, the compound is not limited thereto.

(Adduct of Phosphine Compound and Quinone Compound)

Examples of the adduct of a phosphine compound and a quinone compound include a compound represented by Formula (8).

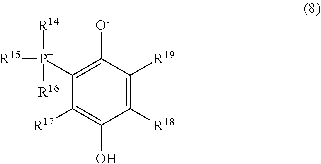

In Formula (8), P represents a phosphorus atom. R¹⁴, R¹⁵, and R¹⁶ each independently represent an alkyl group having 1 to 12 carbon atoms or an aryl group having 6 to 12 carbon atoms. R¹⁷, R¹⁸, and R¹⁹ each independently represent a hydrogen atom or a hydrocarbon group having 1 to 12 carbon atoms, and R¹⁸ and R¹⁹ may form a cyclic structure by being bonded to each other.

As the phosphine compound used in the adduct of a phosphine compound and a quinone compound, for example, triphenylphosphine, tris(alkylphenyl)phosphine, tris(alkoxyphenyl)phosphine, trinaphthylphosphine, and tris(benzyl)phosphine are preferable which have no substituent or have a substituent such as an alkyl group or an alkoxy group on an aromatic ring. Examples of the substituent such as an alkyl group or an alkoxy group include those having 1 to 6 carbon atoms. From the viewpoint of ease of availability, triphenylphosphine is preferable.

Examples of the quinone compound used in the adduct of a phosphine compound and a quinone compound include benzoquinone, anthraquinones, and the like. Among these, in view of storage stability, p-benzoquinone is preferable.

The adduct of a phosphine compound and a quinone compound can be manufactured by, for example, a method of obtaining the adduct by bringing an organic tertiary phosphine into contact with benzoquinones or by mixing the compounds together in a solvent which can dissolve both the compounds. As the solvent, ketones such as acetone or methyl ethyl ketone that hardly dissolve the adduct are preferable, but the solvent is not limited thereto.

As the compound represented by Formula (8), a compound in which R¹⁴, R¹⁵, and R¹⁶ bonded to a phosphorus atom each represent a phenyl group, and R¹⁷, R¹⁸, and R¹⁹ each represent a hydrogen atom, that is, a compound which is an adduct of 1,4-benzoquinone and triphenylphosphine is preferable, because such a compound reduces the thermal elastic modulus of the cured substance of the resin composition.

(Adduct of Phosphonium Compound and Silane Compound)

Examples of the adduct of a phosphonium compound and a silane compound include a compound represented by Formula (9).

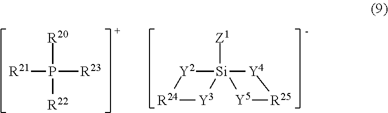

In Formula (9), P represents a phosphorus atom, and Si represents a silicon atom. R²⁰, R²¹, R²², and R²³ each independently represent an organic group having an aromatic ring or a heterocycle or represent an aliphatic group. R²⁴ represents an organic group bonded to the groups Y² and Y³. R²⁵ represents an organic group bonded to the groups Y⁴ and Y⁵. Y² and Y³ each represent a group formed in a case where a proton-donating group releases a proton, and the groups Y² and Y³ in the same molecule form a chelate structure by being bonded to a silicon atom. Y⁴ and Y⁵ each represent a group formed in a case where a proton-donating group releases a proton, and the groups Y⁴ and Y⁵ in the same molecule form a chelate structure by being bonded to a silicon atom. R²⁴ and R²⁵ may be the same as or different from each other, and Y², Y³, Y⁴, and Y⁵ may be the same as or different from each other. Z¹ represents an organic group having an aromatic ring or a heterocycle or represents an aliphatic group.

Examples of R²⁰, R²¹, R²², and R²³ include a phenyl group, a methylphenyl group, a methoxyphenyl group, a hydroxyphenyl group, a naphthyl group, a hydroxynaphthyl group, a benzyl group, a methyl group, an ethyl group, an n-butyl group, an n-octyl group, a cyclohexyl group, and the like. Among these, an aromatic group, having a substituent such as an alkyl group including a phenyl group, a methylphenyl group, a methoxyphenyl group, a hydroxyphenyl group, or a hydroxynaphthyl group, an alkoxy group, or a hydroxyl group, or an unsubstituted aromatic group is preferable.

The groups represented by —Y²—R²⁴—Y³— and —Y⁴—R²⁵—Y⁵— in Formula (9) are groups each constituted with a group formed in a case where a proton donor releases two protons. The proton donor is preferably an organic acid having at least two carboxyl groups or hydroxyl groups in a molecule, more preferably an aromatic compound having at least two carboxyl groups or hydroxyl groups that are connected respectively to carbon atoms adjacent to each other constituting one aromatic ring, and even more preferably an aromatic compound having at least two hydroxyl groups that are connected respectively to carbon atoms adjacent to each other constituting one aromatic ring. Examples of such proton donors include catechol, pyrogallol, 1,2-dihydroxynaphthalene, 2,3-dihydroxynaphthalene, 2,2 ‘-biphenol, 1,1’-bi-2-naphthol, salicylic acid, 1-hydroxy-2-naphthoic acid, 3-hydroxy-2-naphthoic acid, chloranilic acid, tannic acid, 2-hydroxybenzyl alcohol, 1,2-cyclohexanediol, 1,2-propanediol, glycerin, and the like. Among these, catechol, 1,2-dihydroxynaphthalene, and 2,3-dihydroxynaphthalene are more preferable.

Examples of the organic group having an aromatic ring or a heterocycle or the aliphatic group that is represented by Z¹ in Formula (9) include an aliphatic hydrocarbon group such as a methyl group, an ethyl group, a propyl group, a butyl group, a hexyl group, or an octyl group, an aromatic hydrocarbon group such as a phenyl group, a benzyl group, a naphthyl group, or a biphenyl group, a glycidyloxy group such as a glycidyloxypropyl group, a mercaptopropyl group, or an aminopropyl group, an alkyl group having a mercapto group or an amino group, a reactive substituent such as an alkyl group or a vinyl group, and the like. Among these, in view of heat stability and the like, methyl group, an ethyl group, a phenyl group, a naphthyl group, and a biphenyl group are preferable.

Examples of the method for manufacturing the adduct of a phosphonium compound and a silane compound include the following method. First, a silane compound such as phenyltrimethoxysilane and a proton donor such as 2,3-dihydroxynaphthalene are put into a methanol-containing flask and dissolved. Then, a sodium methoxide-methanol solution is added dropwise thereto with stirring at room temperature. Thereafter, a tetrasubstituted phosphinum hydride such as tetraphenyl phosphonium hydride in a methanol solution that is prepared in advance is added dropwise thereto with stirring at room temperature, and as a result, crystals are precipitated. The precipitated crystals are filtered, rinsed with water, and vacuum-dried, and as a result, the adduct of a phosphonium compound and a silane compound is obtained. However, the method is not limited to the above.

Examples of the curing accelerator (F) include the compounds represented by Formulae (6) to (9). Among these, from the viewpoint of the adhesion at a high temperature and the like, the adduct (for example, the compound represented by Formula (8)) of the tetrasubstituted phosphonium compound (for example, the compound represented by Formula (6)) or a phosphine compound and a quinone compound is preferable, and the adduct of a phosphine compound and a quinone compound is more preferable.

Although the content of the curing accelerator (F) is not particularly limited, the lower limit thereof is preferably 0.1% by mass, and more preferably 0.2% by mass. In a case where the content of the curing accelerator (F) is equal to or greater than the aforementioned lower limit, sufficient curing properties and the like can be obtained. The upper limit of the content of the curing accelerator (F) is preferably 1% by mass, and more preferably 0.5% by mass. In a case where the content of the curing accelerator (F) is equal to or less than the aforementioned upper limit, sufficient fluidity and the like can be obtained.

[Other Components]

If necessary, the resin composition for sealing may contain other components. Examples of other components include a coloring agent, an ion scavenger, a release agent, a low-stress component, a flame retardant, and the like.

Examples of the coloring agent include carbon black, red oxide, and the like.

Examples of the ion scavenger include hydrotalcite and the like. The ion scavenger is used as a neutralizing agent in some cases.

Examples of the release agent include natural wax such as carnauba wax, synthetic wax, a higher fatty acid such as zinc stearate and a metal salt thereof, paraffin, and the like.

Examples of the low-stress component include silicone oil, silicone rubber, and the like.

Examples of the flame retardant include aluminum hydroxide, magnesium hydroxide, zinc borate, zinc molybdate, phosphagen, and the like.

In a case where a sulfur atom-containing compound other than mercaptosilane is used in the resin composition for sealing of the present embodiment, the upper limit of the content of the sulfur atom-containing compound other than mercaptosilane is preferably 0.3% by mass, and more preferably 0.1% by mass. In a case where the content of the sulfur atom-containing compound is equal to or less than the aforementioned upper limit, the high-temperature storage characteristics and the like can be improved. The lower limit of the content of the sulfur atom-containing compound other than mercaptosilane may be 0% by mass, and is preferably 0.01% by mass. In a case where the content of the sulfur atom-containing compound other than mercaptosilane is equal to or greater than the aforementioned lower limit, a certain extent of adhesion can be ensured.

The resin composition for sealing of the present embodiment can be prepared by the following method, for example. First, the components described above are homogeneously mixed together at room temperature by using a mixer or the like. Then, if necessary, the mixture is melted and kneaded using a kneading machine such as a heating roll, a kneader, or an extruder. Thereafter, if necessary, the obtained kneaded material is cooled and ground such that the dispersity, fluidity, or the like is adjusted as desired, and in this way, the resin composition for sealing can be obtained. The resin composition for sealing of the present embodiment can be used in the form of powder, varnish by using an organic solvent, or a liquid composition by using a liquid epoxy resin. In a case where the resin composition contains a solvent, the content of each component is expressed in terms of the solid content.

[Electronic Component Device]

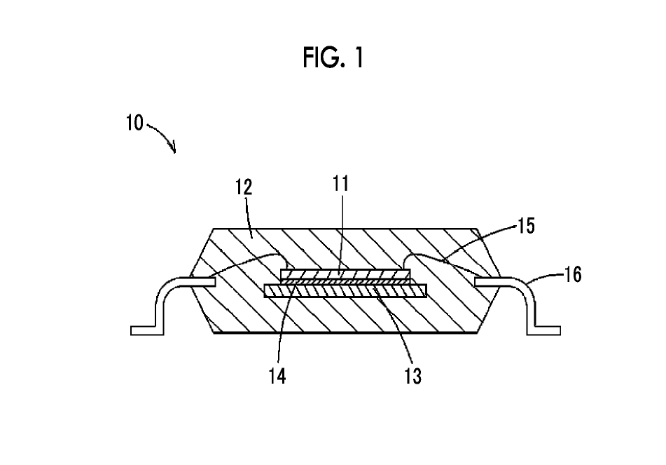

As shown in FIG. 1, an electronic component device 10 according to a second embodiment of the present invention has an electronic component 11 and a sealing material 12 sealing the electronic component 11. Specifically, the electronic component 11 is fixed onto a die pad 13 through a cured die-bonding material 14. The electronic component device 10 has a lead frame 16 connected thereto through a bonding wire 15 from an electrode pad (not shown in the drawing) of the electronic component 11.

The electronic component (element) 11 sealed refers to, for example, a component (element) that produces output in response to input of electric power. Specifically, examples of the electronic component 11 include an integrated circuit, a large-scale integrated circuit, a transistor, a thyristor, a diode, a solid-state imaging element, other semiconductor elements, and the like. The sealing material 12 is a cured substance of the resin composition for sealing according to the first embodiment. As the bonding wire 15, a gold wire, a copper wire, and the like can be used. As the material of the lead frame 16, copper, a copper alloy, a 42 alloy, or the like can be used.

The electronic component device 10 can be in the form of, for example, a dual in-line package (DIP), a plastic leaded chip carrier (PLCC), a quad flat package (QFP), a low-profile quad flat package (LQFP), a small outline package (SOP), a small outline J-leaded package (SOJ), a thin small outline package (TSOP), a thin quad flat package (TQFP), a tape carrier package (TCP), a ball grid array (BGA), and a chip size package (CSP), but are not limited to these.

The electronic component device 10 is manufactured by, for example, fixing the electronic component 11 onto the die pad 13 by using a die-bonding material, connecting the lead frame 16 thereto through the bonding wire 15, and then sealing the structure (material to be sealed) by using the resin composition for sealing. The sealing can be performed by, for example, installing a material to be sealed, which is formed of the electronic component 11 or the like, in a mold cavity, then molding and curing the resin composition for sealing by a molding method such as transfer molding, compression molding, or injection molding. If necessary, the electronic component device 10 in which the electronic component 11 is sealed is mounted on an electronic instrument or the like after the resin composition for sealing is cured for about 10 minutes to 10 hours at a temperature of about 80° C. to 200° C.

In the electronic component device 10, the resin composition for sealing according to the first embodiment is used as the sealing material 12. Accordingly, the adhesion between the sealing material 12 and the electronic component 11, the bonding wire 15, the lead frame 16, and the like is sufficient, and the high-temperature storage characteristics thereof are excellent. Particularly, even in a case where a copper wire is used as the bonding wire 15 or the like, sufficient high-temperature storage characteristics and the like can be exhibited.

The present invention is not limited to the embodiments described above, and the constitution of the present invention can be modified within a scope that does not depart from the gist of the present invention.

### EXAMPLES

Hereinafter, the present invention will be specifically described using examples, but the present invention is not limited to the examples.

The components used in Examples 1 to 8 and Comparative Examples 1 and 2 are as below.

Epoxy Resin (A)
Epoxy resin 1: phenolaralkyl-type epoxy resin having phenylene skeleton (trade name: NC-2000 manufactured by Nippon Kayaku Co., Ltd.)
Epoxy resin 2: biphenyl-type epoxy resin (trade name: YX4000K manufactured by Mitsubishi Chemical Corporation)

Curing Agent (B)
Phenolic resin-based curing agent 1: phenolaralkyl resin having biphenylene skeleton (trade name: GPH-65 manufactured by Nippon Kayaku Co., Ltd.)
Phenolic resin-based curing agent 2: phenol novolac resin (trade name: PR-HF-3 manufactured by Sumitomo Bakelite Co., Ltd.)

Inorganic Filler (C)
Inorganic filler 1: spherical molten silica having average particle size of 30 μm and specific surface area of 1.7 m²/g
Inorganic filler 2: spherical molten silica having average particle size of 0.5 μm and specific surface area of 5.9 m²/g

Compound (D)
Compound 1: N-(2H-1,2,4-triazol-5-yl)salicylamide represented by Formula (10) (CDA-1 manufactured by ADEKA CORPORATION)

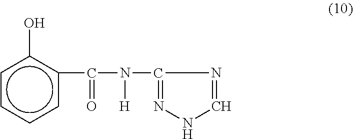

Compound 2: 2-hydroxybenzoic acid
Compound 3: methyl 4-hydroxybenzoate

Compound (d)
Compound 4: 3-amino-5-mercapto-1,2,4-triazole represented by Formula (11)

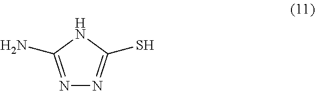

Coupling Agent (E)
Coupling agent 1: N-phenyl-γ-aminopropyl trimethoxysilane
Coupling agent 2: γ-mercaptopropyl trimethoxysilane

Curing Accelerator (F)
Curing accelerator 1: triphenylphosphine-1,4-benzoquinone adduct represented by Formula (12) synthesized by the following method

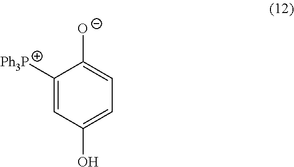

(Synthesis of Curing Accelerator 1)

A separable flask equipped with a cooling tube and a stirring device was filled with 6.49 g (0.060 mol) of benzoquinone, 17.3 g (0.066 mol) of triphenylphosphine, and 40 ml of acetone, and the components were reacted by stirring at room temperature. The precipitated crystals were washed with acetone and then filtered and dried, thereby obtaining a curing accelerator 1 which were dark green crystals.
Curing accelerator 2: tetrasubstituted phosphonium compound represented by Formula (13) synthesized by the following method

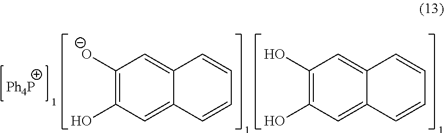

(Synthesis of Curing Accelerator 2)

A separable flask equipped with a cooling tube and a stirring device was filled with 12.81 g (0.080 mol) of 2,3-dihydroxynaphthalene, 16.77 g (0.040 mol) of tetraphenylphosphonium bromide, and 100 ml of methanol, and the components were homogeneously dissolved by stirring. A sodium hydroxide solution, which was obtained by dissolving in advance 1.60 g (0.04 ml) of sodium hydroxide in 10 ml of methanol, was slowly added dropwise to the solution in the flask, and as a result, crystals were precipitated. The precipitated crystals were filtered, rinsed with water, and vacuum-dried, thereby obtaining a curing accelerator 2.

Other Components
Coloring agent: carbon black
Ion scavenger: hydrotalcite (DHT-4H manufactured by Kyowa Chemical Industry Co., Ltd.)
Release agent: carnauba wax (NIKKO CARNAUBA manufactured by Nikko Fine Products Co., Ltd.)

### Example 1

The epoxy resin 1 (8.7 parts by mass), the phenolic resin-based curing agent 1 (6.4 parts by mass), the inorganic filler 1 (73.72 parts by mass), the inorganic filler 2 (10 parts by mass), the compound 1 (0.03 parts by mass), the coupling agent 1 (0.2 parts by mass), the curing accelerator 1 (0.25 parts by mass), the coloring agent (0.4 parts by mass), the ion scavenger (0.1 parts by mass), and the release agent (0.2 parts by mass) were mixed together at room temperature by using a mixer and then kneaded with a roll at 70° C. to 100° C. Thereafter, the kneaded material was cooled and then ground, thereby obtaining a resin composition for sealing of Example 1.

### Examples 2 to 8 and Comparative Examples 1 and 2

Resin compositions for sealing of Examples 2 to 8 and Comparative Examples 1 and 2 were obtained in the same manner as in Example 1, except that the amount of each component used (formulated) was changed as shown in Table 1.

[Manufacturing of Semiconductor Device (Electronic Component Device)]

A test element group (TEG) chip (3.5 mm×3.5 mm) was mounted on 352-pin BGA (substrate: bismaleimide.triazine resin/glass cloth substrate having thickness of 0.56 mm, package size: 30 mm×30 mm with thickness of 1.17 mm). Then, by using a copper wire (copper purity: 99.99% by mass, diameter: 25 μm), the resultant was wire-bonded to an electrode pad at a wire pitch of 80 μm.

The structure obtained in this way was sealed and molded using the resin composition for sealing of each of the examples and comparative examples by using a low-pressure transfer molding machine (“Y series” manufactured by TOWA Corporation), under the conditions of a mold temperature of 175° C., an injection pressure of 6.9 MPa, and a curing time of 2 minutes. In this way, a 352-pin BGA package was prepared. Then, the obtained BGA package was post-cured under the conditions of 175° C. and 4 hours, thereby obtaining a semiconductor device (electronic component device).

[Evaluation]

The obtained resin composition for sealing and semiconductor device of each of the examples and comparative examples were evaluated by the following method. The evaluation results are shown in Table 1.

[Adhesion]

The adhesion with respect to each metal (Ag, Cu, pre-plated frame (PPF), Ni) was evaluated by the following method. On a substrate formed of each of the aforementioned metals, the obtained resin composition for sealing was integrally molded under the conditions of 175° C., 6.9 MPa, and 2 minutes and then post-cured for 4 hours at 175° C. Thereafter, the shear bond strength thereof with respect to each substrate was measured under the condition of 260° C. The numerical values shown in Table 1 are relative values based on Comparative Example 2.

[High-Temperature Storage Characteristics]

The obtained semiconductor devices were subjected to a high-temperature storage test (HTSL) by the following method. Each of the semiconductor devices was stored under the condition of a temperature of 200° C. for 1,000 hours. For the semiconductor device having undergone storage, an electrical resistivity between the wire and the electrode pad was measured. A semiconductor device showing an average electrical resistivity that was less than 110% of an average initial resistivity thereof was denoted by A; a semiconductor device showing an electrical resistivity that was equal to or higher than 110% and equal to or lower than 120% of an average initial resistivity thereof was denoted by B; and a semiconductor device showing an electrical resistivity that was higher than 120% of an average initial resistivity thereof was denoted by X.

TABLE 1

| | | | | | | | | | | Compar- | Compa- |
|---|---|---|---|---|---|---|---|---|---|---|---|
| | | | | | | | | | | ative | rative |
| | | Example 1 | Example 2 | Example 3 | Example 4 | Example 5 | Example 6 | Example 7 | Example 8 | Example 1 | Example 2 |
| [A] | Epoxy resin 1 | 8.7 | 8.7 | 8.7 | | 8.7 | 8.7 | | 8.7 | 8.7 | 8.7 |
| | Epoxy resin 2 | | | | 4.4 | | | 4.4 | | | |
| [B] | Phenolic | 6.4 | 6.4 | 6.4 | | 6.4 | 6.4 | | 6.4 | 6.4 | 6.4 |
| | resin-based | | | | | | | | | | |
| | curing | | | | | | | | | | |
| | agent 1 | | | | | | | | | | |
| | Phenolic | | | | 3.5 | | | 3.5 | | | |
| | resin-based | | | | | | | | | | |
| | curing | | | | | | | | | | |
| | agent 2 | | | | | | | | | | |
| [C] | Inorganic | 73.72 | 73.72 | 73.7 | 75.92 | 73.72 | 73.72 | 75.92 | 73.6 | 73.75 | 73.72 |
| | filler 1 | | | | | | | | | | |
| | Inorganic | 10 | 10 | 10 | 15 | 10 | 10 | 15 | 10 | 10 | 10 |
| | filler 2 | | | | | | | | | | |
| [D] | Compound 1 | 0.03 | | | 0.03 | 0.03 | | 0.03 | 0.15 | | |
| | Compound 2 | | 0.03 | | | | 0.03 | | | | |
| | Compound 3 | | | 0.05 | | | | | | | |
| [d] | Compound 4 | | | | | | | | | | 0.03 |
| [E] | Coupling | 0.2 | 0.2 | 0.2 | 0.2 | 0.15 | 0.15 | 0.15 | 0.2 | | 0.15 |
| | agent 1 | | | | | | | | | | |
| | Coupling | | | | | 0.05 | 0.05 | 0.05 | | 0.2 | 0.05 |
| | agent 2 | | | | | | | | | | |
| [F] | Curing | 0.25 | 0.25 | 0.25 | | 0.25 | 0.25 | | 0.25 | 0.25 | 0.25 |
| | accelerator 1 | | | | | | | | | | |
| | Curing | | | | 0.25 | | | 0.25 | | | |
| | accelerator 2 | | | | | | | | | | |
| Other | Coloring agent | 0.4 | 0.4 | 0.4 | 0.4 | 0.4 | 0.4 | 0.4 | 0.4 | 0.4 | 0.4 |
| compo- | Ion scavenger | 0.1 | 0.1 | 0.1 | 0.1 | 0.1 | 0.1 | 0.1 | 0.1 | 0.1 | 0.1 |
| nents | Release agent | 0.2 | 0.2 | 0.2 | 0.2 | 0.2 | 0.2 | 0.2 | 0.2 | 0.2 | 0.2 |
| Total | | 100 | 100 | 100 | 100 | 100 | 100 | 100 | 100 | 100 | 100 |
| Evalu- | Adhesion ¹⁾ Ag | 1.1 | 1 | 1 | 1.1 | 1.5 | 1.3 | 1.5 | 1.2 | 0.7 | 1 |
| ation | (260° C.) | | | | | | | | | | |
| | Adhesion ¹⁾ Cu | 1.2 | 1 | 1 | 1.2 | 1.8 | 1.5 | 1.7 | 1.3 | 0.7 | 1 |
| | (260° C.) | | | | | | | | | | |
| | Adhesion ¹⁾ PPF | 1.1 | 1 | 1 | 1.2 | 1.4 | 1.3 | 1.3 | 1.1 | 0.6 | 1 |
| | (260° C.) | | | | | | | | | | |
| | Adhesion ¹⁾ Ni | 1.3 | 1.1 | 1 | 1.2 | 1.9 | 1.6 | 1.7 | 1.4 | 0.7 | 1 |
| | (260° C.) | | | | | | | | | | |
| | High-temperature | A | A | B | A | A | A | A | A | X | X |
| | storage | | | | | | | | | | |
| | characteristics | | | | | | | | | | |

¹⁾ Relative value based on Comparative Example 2

As is evident from Table 1, the resin compositions for sealing of examples have sufficient adhesion, and the high-temperature storage characteristics of the obtained electronic component devices (semiconductor devices) are also excellent. Specifically, in Comparative Example 1 that does not contain the compound (D), the adhesion and the high-temperature storage characteristics are relatively poor, the structure represented by Formula (1) does not exist. In Comparative Example 2 that contains the compound 4 (3-amino-5-mercapto-1,2,4-triazole) having a mercapto group, the adhesion is higher than that in Comparative Example 1, but the high-temperature storage characteristics are not improved. In contrast, in Examples 1 to 8 that contain the compound (D), the adhesion is equivalent to or better than the adhesion of Comparative Example 2, and the high-temperature storage characteristics are improved. Particularly, it is understood that in a case where the compound 1 having an amino group or the compound 2 having a hydroxyl group is used as the compound (D), the adhesion and the high-temperature storage characteristics are further improved (Examples 1, 2, and 4 to 8). Furthermore, it is understood that in a case where the compound 1 having an amino group is used, the adhesion and the high-temperature storage characteristics are further improved (Examples 1, 4, 5, 7, and 8). It is also understood that in a case where the compound (D) and mercaptosilane (coupling agent 2) as the coupling agent (E) are used in combination, excellent high-temperature storage characteristics can be maintained even though the resin composition does not contain the compound (coupling agent 2) having a mercapto group, and the adhesion is further improved (Examples 5 to 7).

1. A resin composition for sealing comprising:
an epoxy resin (A);
a curing agent (B);
an inorganic filler (C); and
a compound (D) represented by Formula (1) 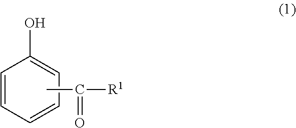
(in Formula (1), R¹ represents a polar group or a hydrocarbon group).

2. The resin composition for sealing according to claim 1,
wherein R¹ represents a hydroxyl group, an alkoxy group, or a primary, secondary, or tertiary amino group.

3. The resin composition for sealing according to claim 2,
wherein R¹ represents a secondary or tertiary amino group.

4. The resin composition for sealing according to claim 3,
wherein R¹ is represented by Formula (2).

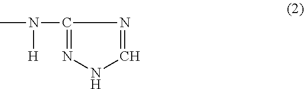

5. The resin composition for sealing according to claim 1,
wherein a content of the compound (D) is equal to or greater than 0.01% by mass and equal to or less than 1% by mass with respect to a total amount of the resin composition for sealing.

6. The resin composition for sealing according to any claim 1, further comprising:
a coupling agent (E),
wherein the coupling agent (E) includes a silane coupling agent (E1) having a mercapto group.

7. The resin composition for sealing according to claim 6,
wherein a content of the silane coupling agent (E1) having a mercapto group is equal to or greater than 0.01% by mass and equal to or less than 0.1% by mass with respect to the total amount of the resin composition for sealing.

8. The resin composition for sealing according to claim 1, further comprising:
a curing accelerator (F),
wherein the curing accelerator (F) is at least one kind of phosphorus atom-containing compound selected from the group consisting of a tetrasubstituted phosphonium compound and an adduct of a phosphine compound and a quinone compound.

9. The resin composition for sealing according to claim 1 that is used for sealing an electronic component to which a copper wire is connected.

10. An electronic component device comprising:
an electronic component; and
a sealing material sealing the electronic component,
wherein the sealing material is a cured substance of the resin composition for sealing according to claim 1.

11. The electronic component device according to claim 10, further comprising:
a copper wire connected to the electronic component.
